(19) United States
(12) Patent Application Publication
(10) Pub. No.: US 2021/0104021 A1
(43) Pub. Date: Apr. 8, 2021

(54) METHOD AND APPARATUS FOR PROCESSING IMAGE NOISE

(71) Applicant: LG ELECTRONICS INC., Seoul (KR)

(72) Inventors: Young Ho SOHN, Seoul (KR); Young Yeon SEO, Seoul (KR); Chang Jun YEO, Seoul (KR)

(73) Assignee: LG ELECTRONICS INC., Seoul (KR)

(21) Appl. No.: 16/742,257

(22) Filed: Jan. 14, 2020

(30) Foreign Application Priority Data
Oct. 2, 2019 (KR) 10-2019-0122340

(51) Int. Cl. G06T 5/00; G06T 5/20

(52) U.S. Cl. CPC G06T 5/002; G06T 2207/20081; G06T 2207/20084; G06T 5/20

(57) ABSTRACT

Disclosed are an image noise processing method and apparatus. The image noise processing method includes inputting a target image including a low light level noise, estimating a noise level, and a selective processing of the target image by a denoising sub-network corresponding to the noise level. According to the present disclosure, it is possible to selectively apply a denoising neural network through a 5G network on the basis of an estimation of a noise level.

### CROSS-REFERENCE TO RELATED APPLICATION

This present application claims benefit of priority to Korean Patent Application No. 10-2019-0122340, entitled “METHOD AND APPARATUS FOR PROCESSING IMAGE NOISE,” filed on Oct. 2, 2019 in the Korean Intellectual Property Office, the entire disclosure of which is incorporated herein by reference.

### BACKGROUND

### 1. Technical Field

The present disclosure relates to an image noise processing method and apparatus, and, more particularly, to a method for removing noise included in an image obtained in a low light environment using a deep learning-based neural network, and an image noise processing apparatus using same.

### 2. Description of Related Art

An image collected in a low light environment inevitably includes noise. Since noise is amplified as ISO sensitivity is increased, the amount of noise in a low light level image may increase further.

Although a high sensitivity and low noise sensing technology is being developed in accordance with the development of an image sensor technology, there is still a limit in terms of the ability to fundamentally avoid low light level noise caused by an insufficient absolute quantity of quanta arriving at an image sensor.

Korean Patent Registration No. 10-1442153 (Sep. 12, 2014) discloses a low light level image processing method and system as a related art. According to this related art, it is necessary to obtain first and second images having different light levels and sensitivities, and the noise of the second image can be removed by correcting the second image using a motion vector of the second image based on the first image. However, according to this related art, it is necessary to prepare two images, and the noise removal effect is low when noise is included in the first image.

Korean Patent Registration No. 10-1555056 (Sep. 16, 2015) discloses a three-dimensional digital noise removal device and method for a camera as another related art. According to this related art, three-dimensional digital noise can be removed by setting step numbers, which is the number of frames according to the range of a light level value, differently from each other. However, application of this related art is limited to a video and three-dimensional digital noise.

### SUMMARY OF THE INVENTION

An aspect of the present disclosure is to address the shortcoming of the prior art in which image noise can be removed only by using two images, i.e., a target image and a reference image to be compared therewith.

Another aspect of the present disclosure is to address the shortcoming of the prior art in which image noise removal is limited to three-dimensional digital noise.

Another aspect of the present disclosure is to address the shortcoming of the prior art in which performance is limited since noise is removed using a blind noise removal method without an image noise estimation.

Another aspect of the present disclosure is to address the shortcoming of the prior art in which even when an image noise is estimated, a result of the estimation cannot be reflected in a processing of the noise.

While this disclosure includes specific embodiments, it will be apparent to one of ordinary skill in the art that various changes in form and details may be made in these embodiments without departing from the spirit and scope of claims and their equivalents. The embodiments described herein are to be considered in a descriptive sense only, and not for purposes of limitation. Further, it is understood that the objects and advantages of the present disclosure may be embodied by the means and a combination thereof in claims.

An image noise processing method according to an exemplary embodiment of the present disclosure may include inputting a target image through a neural network comprising a plurality of sub-networks, estimating the noise level of the target image using a noise estimation sub-network among the plurality of sub-networks, and processing the target image using a denoising sub-network corresponding to the noise level among the plurality of sub-networks.

The noise may include at least one of an addictive white Gaussian noise, a non-Gaussian white noise, or a photon shot noise.

The noise may follow at least one of a Gaussian distribution, a Poisson distribution, or a Bernoulli distribution.

The estimating of the noise level of the target image may include a block based approach or a filter based approach.

The estimating of the noise level of the target image may include dividing the target image into a plurality of sub-images according to the estimated noise level, and generating a noise map indicating a noise distribution for the sub-image. The processing of the target image may include processing the target image using the denoising sub-network corresponding to the noise level of the sub-image on the basis of the noise map.

The processing of the target image may include selecting the denoising sub-network corresponding to the noise level according to at least one of the number of layers constituting the neural network, an amount of training data sets, and a number of times the training data sets have been used for learning.

The image noise processing method may further include training the denoising sub-network using residual learning based on learning of a noise difference due to a difference in a pair of input images.

The training of the denoising sub-network may include inputting a pair of input images including noise, analyzing a noise difference using a difference between the input images, and separating a latent clean image from one input image of the pair of input images on the basis of the noise difference in order to output a residual image.

The pair of input images may correspond to images having the same object as a subject and captured using the same focal distance and the same composition.

The noise of the pair of input images may include noise which naturally occurs due to an image having been captured in a low light environment.

The processing of the target image may include outputting noise extracted from the target image according to a training result of residual learning of the denoising sub-network, and outputting a latent clean image obtained by removing noise from the target image on the basis of the extracted noise.

An image noise processing apparatus according to an exemplary embodiment may include a neural network including a plurality of sub-networks, and a processor, which controls the neural network to process noise of an inputted target image. The neural network may include a noise estimation sub-network, which estimates a grade of noise level of the target image, and a plurality of deep learning-based denoising sub-networks, which process the noise of the target image using a denoising sub-network corresponding to the noise level.

The noise estimation sub-network may estimate the noise level of the target image using a block based approach or a filter based approach.

The processor may divide the target image into a plurality of sub-images according to the estimated noise level, may control the noise estimation sub-network to generate a noise map indicating noise distribution for the sub-image, and may process the target image using the denoising sub-network corresponding to the noise level of the sub-image on the basis of the noise map.

The processor may select the denoising sub-network corresponding to the noise level according to at least one of the number of layers constituting the neural network, an amount of training data sets, and a number of times the training data sets have been used for learning.

The denoising sub-network may perform training for outputting a residual image which only includes noise with respect to input data of a pair of input images by using residual learning based on learning of a noise difference due to a difference in the pair of input images.

The denoising sub-network may be trained to analyze, with respect to a pair of input images, a noise difference using a difference between the input images, and separate a latent clean image from one input image of the pair of input images on the basis of the noise difference in order to output a residual image.

The pair of input images may correspond to images having the same object as a subject and captured using the same focal distance and the same composition.

The noise of the pair of input images may include noise which naturally occurs due to an image having been captured in a low light environment.

The processor may control the denoising sub-network to output noise extracted from the target image according to a training result of residual learning of the denoising sub-network, and may output a latent clean image obtained by removing noise from the target image on the basis of the extracted noise.

According to an exemplary embodiment of the present disclosure, a low light level noise may be selectively processed by a denoising sub-network having appropriate performance according to a result of noise level estimation.

Furthermore, noise of a low light level image may be efficiently removed through residual learning using subtraction between noises.

Furthermore, a low light level noise may be removed through learning for which an image including an actual noise, rather than a virtual noise, is used as training data.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is an exemplary diagram illustrating quantum properties of light related to image noise according to an exemplary embodiment of the present disclosure;

FIG. 2 in an exemplary diagram illustrating a network environment in which an image noise processing apparatus according to an exemplary embodiment of the present disclosure is connected;

FIG. 3 is a block diagram illustrating a terminal corresponding to an image noise processing apparatus according to an exemplary embodiment of the present disclosure;

FIG. 4 is a block diagram illustrating the memory of FIG. 3;

FIG. 5 is a block diagram illustrating a learning device according to an exemplary embodiment of the present disclosure;

FIG. 6 is a flowchart illustrating an image noise processing method according to an exemplary embodiment of the present disclosure;

FIG. 7 is an exemplary diagram illustrating a denoising sub-network according to an exemplary embodiment of the present disclosure;

FIG. 8 is an exemplary diagram illustrating residual learning according to an exemplary embodiment of the present disclosure;

FIG. 9 is an exemplary diagram illustrating batch normalization according to an exemplary embodiment of the present disclosure;

FIG. 10 is an exemplary diagram illustrating a neural network according to an exemplary embodiment of the present disclosure; and

FIG. 11 is an exemplary diagram illustrating a denoising sub-network according to an exemplary embodiment of the present disclosure.

### DETAILED DESCRIPTION

The embodiments disclosed in the present specification will be described in greater detail with reference to the accompanying drawings, and throughout the accompanying drawings, the same reference numerals are used to designate the same or similar components and redundant descriptions thereof are omitted. As used herein, the terms “module” and “unit” used to refer to components are used interchangeably in consideration of convenience of explanation, and thus, the terms per se should not be considered as having different meanings or functions. In addition, in the following description of the embodiments disclosed in this specification, the detailed description of related known technology will be omitted when it may obscure the subject matter of the embodiments according to the present disclosure. Further, the accompanying drawings are provided for more understanding of the embodiment disclosed in the present specification, but the technical spirit of the present disclosure is not limited by the accompanying drawings. It should be understood that all changes, equivalents, and alternatives included in the spirit and the technical scope of the present disclosure are included.

Although the terms first, second, third, and the like, may be used herein to describe various elements, components, regions, layers, and/or sections, these elements, components, regions, layers, and/or sections should not be limited by these terms. These terms are generally used only to distinguish one element from another.

Similarly, it will be understood that when an element is referred to as being “connected,” “attached,” or “coupled” to another element, it can be directly connected, attached, or coupled to the other element, or intervening elements may be present. In contrast, when an element is referred to as being “directly on,” “directly engaged to,” “directly connected to,” or “directly coupled to” another element or layer, there may be no intervening elements or layers present.

A camera installed in a smartphone, which is a mobile terminal, includes a miniaturized module and sensor. Therefore, an image captured by a smartphone in an inadequate environment, such as a dark place or inside, may have a deteriorated image quality due to noise. Research about post-processing of images for the removal of image noise is being actively carried out in order to improve image quality. However, algorithms optimized for smartphones are required to be developed so as to be directly used in smartphones having limited computational capabilities. However, algorithms, optimized so as to be able to be directly used in smartphones having limited computational capabilities, are required.

Image noise refers to unnecessary pixel information which damages a target image mixed during a process of acquisition, conversion, and transmission of an image. Among various noises, a read noise is one electronically generated in an amplifier. A dark noise is one generated in a sensor due to thermal electrons. A photon shot noise is one caused by the properties of light, and it is difficult to remove the photon shot noise in spite of an improvement in relevant technology.

Pixels of a CCD or CMOS image sensor absorb photons to generate electrons. The amount of photons arriving at each pixel is measured by counting the number of electrons. However, since the photons fall randomly, there is an unavoidable limitation in the measuring of an average intensity of light by counting the number of photons.

In general, when an image is obtained by a camera installed in a smartphone in a low light environment, a hardware noise, which occurs during an operation process of an image sensor, i.e., the photon shot noise, occurs.

The photon shot noise may disperse over an entire image that has insufficient exposure, and may more densely concentrate on dark pixels than on bright pixels. Light moves as packets having irregular density due to the quantum properties of light. Therefore, a standard deviation of the number of photons that have arrived may significantly vary according to the length of a light exposure time.

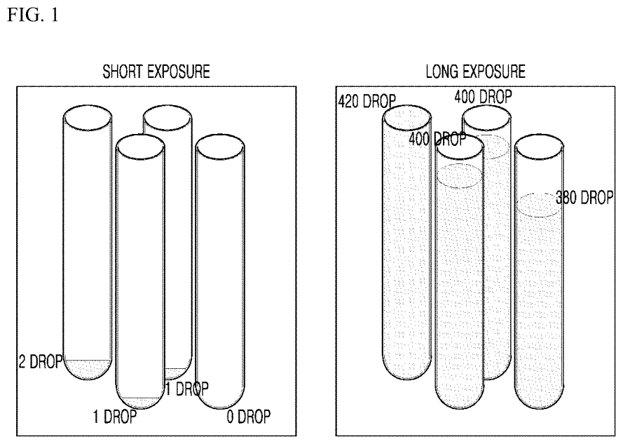

FIG. 1 is an exemplary diagram illustrating quantum properties of light related to image noise according to an exemplary embodiment of the present disclosure.

The left-side area of FIG. 1 illustrates a model corresponding to a case in which a light exposure time is short. The right-side area of FIG. 1 illustrates a model corresponding to a case in which where the light exposure time is long.

Here, photons which constitute light may be compared to raindrops. Therefore, the standard deviation of the number of raindrops between beakers is larger in a case in which a rain exposure time is short than in the case where the rain exposure time is long. Likewise, the standard deviation of the number of photons that have arrived between pixels is larger in the case of short exposure than in the case of long exposure, and thus the photon shot noise is also larger in the case of short exposure than in the case of long exposure.

A typical image noise removal method may be classified into a local method and a non-local means method. The local method uses a mean value, a median value, a maximum value, or a minimum value of the values of neighboring pixels based on a center pixel which is to be restored. According to this method, information that may be referred to by the center pixel is limited to a peripheral area. Therefore, using the local method, it is difficult to suppress noise while maintaining image detail information.

On the other hand, according to the non-local means method, target data is restored by using weights determined by similarities between a pixel which is to be restored and pixels in a non-local range, i.e., a search window range. However, according to this method, there is a limitation in suppressing noise since a center pixel is replaced with other pixels.

An image noise is expressed using a noise model as below.

x=y+v [Equation 1]

In Equation 1, x denotes pixel data of an image including noise, y denotes pixel data of an image without noise, and v denotes pixel data of noise. The pixel data of the noise v may be expressed as a product of a random variable z and a standard deviation 6, wherein the random variable z and the standard deviation 6 indicate the degree of noise. The random variable z may be a random variable of a standard normal distribution, Poisson distribution, or Bernoulli distribution depending on the type of the random variable.

There a number of indices indicating quality of an image including noise.

$$SSIM ( x , y ) = \frac{( 2 {μ}_{x} {μ}_{y} + {c}_{1} ) ( 2 {σ}_{xy} + {c}_{2} )}{( {μ}_{x}^{2} + {μ}_{y}^{2} + {c}_{1} ) ( {σ}_{x}^{2} + {σ}_{y}^{2} + {c}_{2} )} \\ {c}_{1} = {( {k}_{1} \cdot 255 )}^{2} , {c}_{2} = {( {k}_{2} \cdot 255 )}^{2} \qquad [ Equation 2 ]$$

Here, SSIM denotes structural similarity index. This equation indicates a method of measuring the similarity between an image including a distortion due to compression and conversion, and an original image. SSIM, which is a method of evaluating image quality, effectively reflects a human visual system (HVS). SSIM is used when measuring the quality of an image after calculating a structural similarity by extracting structural information about the image, i.e., luminance, contrast, and structure. The closer to 1 the SSIM is, the higher the similarity is. On the other hand, the closer to 0 the SSIM is, the lower the similarity is. In Equation 2, x denotes a target image, y denotes a restored image, and μₓ and μ_{y} denote average gray levels of the images x and y. σ²ₓ, σ²_{y}, and σ_{xy} denote a covariance of x and y, and c₁ and c₂ are weak denominators for stabilizing the equation.

$$PSNR = 10 {log}_{10} \frac{{255}^{2}}{{( {𝓎}_{i} - {d}_{i} )}^{2}} ( dB ) \qquad [ Equation 3 ]$$

PSNR denotes a peak signal-to-noise ratio. The PSNR, which is similar to SNR, indicates the peak signal-to-noise ratio that a signal may have, and is mostly used when evaluating image quality loss information related to loss compression of an image or video. Since this PSNR is measured in log scales, [db] is mostly used as a unit thereof. The less the noise, the higher the PSNR. In Equation 3, yᵢ denotes an estimated value, and di denotes an actual measurement of a pixel value.

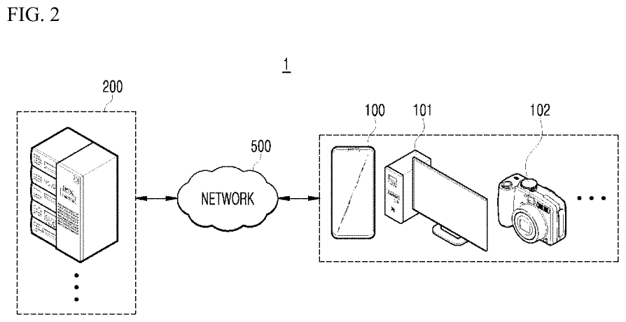

FIG. 2 is an exemplary diagram illustrating a network environment in which an image noise processing apparatus according to an exemplary embodiment of the present disclosure is connected.

Referring to FIG. 2, a network environment 1 includes a terminal 100, a desktop computer 101, and a digital camera 102 as image noise processing apparatuses and a learning device 200, and a network 500 for communicatively connecting the foregoing elements according to an exemplary embodiment of the present disclosure.

The image noise processing apparatus according to an exemplary embodiment of the present disclosure may be represented as the terminal 100, a desktop computer, a digital camera, or the like according to the form of implementation, but is not limited to the range illustrated in FIG. 2.

Hereinafter, the terminal 100, among various examples of the image noise processing apparatus, will be described as the image noise processing apparatus 100 according to an exemplary embodiment of the present disclosure. Unless other particular assumptions or conditions are specified, description of the terminal 100 may directly apply to other types of the image noise processing apparatus, such as the desktop computer 101 and the digital camera 102.

The image noise processing apparatus 100 may remove image noise using the learning device 200. That is, the image noise processing apparatus 100 may use an artificial intelligence model, such as a neural network, stored by the learning device 200, having been trained by the learning device 200. Furthermore, the image noise processing apparatus 100 may remove image noise using an artificial intelligence model downloaded to and stored in the image noise processing apparatus 100 and trained by the learning device 200. Artificial intelligence will be described in detail later.

The learning device 200 may train and evaluate an artificial intelligence model, such as various neural networks, used for noise removal according to an exemplary embodiment of the present disclosure. The completed artificial intelligence model, having been evaluated, may be used by the image noise processing apparatus 100, while being stored in the learning device 200 or the image noise processing apparatus 100. The learning device 200 will be described in detail.

The network 500 may be an appropriate communication network including wired and wireless networks, such as a local area network (LAN), a wide area network (WAN), the Internet, the Intranet, and the extranet and a mobile network such as cellular, 3G, LTE, 5G, a Wi-Fi network, an AD hoc network, and a combination thereof.

The network 500 may include connection of network elements such as a hub, a bridge, a router, a switch, and a gateway. The network 500 may include one or more connected networks including a public network such as the Internet and a private network such as a secure corporate private network, for example, multiple network environments. Access to the network 500 may be provided via one or more wired or wireless access networks.

The terminal 100 may transmit and receive data with a learning device 200 which is a learning device, through a 5G network. Specifically, the image noise processing device 102 implemented as a terminal 101 may perform data communication with the learning device 200 using at least one service of enhanced mobile broadband (eMBB), ultra-reliable and low latency communications (URLLC), and massive machine-type communications (mMTC) through the 5G network.

The enhanced mobile broadband (eMBB) which is a mobile broadband service provides multimedia contents, wireless data access, and so forth. Further, more improved mobile services such as a hotspot and a wideband coverage for receiving mobile traffic that are tremendously increasing can be provided through eMBB. Through a hotspot, the large-volume traffic may be accommodated in an area where user mobility is low and user density is high. Through broadband coverage, a wide-range and stable wireless environment and user mobility may be guaranteed.

The URLLC service defines the requirements that are far more stringent than existing LTE in terms of reliability and transmission delay of data transmission and reception, and corresponds to a 5G service for production process automation in the industrial field, telemedicine, remote surgery, transportation, safety, and the like.

mMTC is a transmission delay-insensitive service that requires a relatively small amount of data transmission. A much larger number of terminals, such as sensors, than a general portable phone may be connected to a wireless access network by mMTC at the same time. In this case, the price of the communication module of a terminal should be low and a technology improved to increase power efficiency and save power is required to enable operation for several years without replacing or recharging a battery.

The artificial intelligence (AI) is one field of computer science and information technology that studies methods to make computers mimic intelligent human behaviors such as reasoning, learning, self-improving and the like.

In addition, the artificial intelligence does not exist on its own, but is rather directly or indirectly related to a number of other fields in computer science. In recent years, there have been numerous attempts to introduce an element of the artificial intelligence into various fields of information technology to solve problems in the respective fields.

Machine learning is an area of artificial intelligence that includes the field of study that gives computers the capability to learn without being explicitly programmed.

Specifically, the Machine Learning can be a technology for researching and constructing a system for learning, predicting, and improving its own performance based on empirical data and an algorithm for the same. The algorithms of the Machine Learning take a method of constructing a specific model in order to obtain the prediction or the determination based on the input data, rather than performing the strictly defined static program instructions.

Numerous machine learning algorithms have been developed for data classification in machine learning. Representative examples of such machine learning algorithms for data classification include a decision tree, a Bayesian network, a support vector machine (SVM), an artificial neural network (ANN), and so forth.

Decision tree refers to an analysis method that uses a tree-like graph or model of decision rules to perform classification and prediction.

Bayesian network may include a model that represents the probabilistic relationship (conditional independence) among a set of variables. Bayesian network may be appropriate for data mining via unsupervised learning.

SVM may include a supervised learning model for pattern detection and data analysis, heavily used in classification and regression analysis.

ANN is a data processing system modelled after the mechanism of biological neurons and interneuron connections, in which a number of neurons, referred to as nodes or processing elements, are interconnected in layers.

ANNs are models used in machine learning and may include statistical learning algorithms conceived from biological neural networks (particularly of the brain in the central nervous system of an animal) in machine learning and cognitive science.

ANNs may refer generally to models that have artificial neurons (nodes) forming a network through synaptic interconnections, and acquires problem-solving capability as the strengths of synaptic interconnections are adjusted throughout training.

The terms ‘artificial neural network’ and ‘neural network’ may be used interchangeably herein.

An ANN may include a number of layers, each including a number of neurons. In addition, the Artificial Neural Network can include the synapse for connecting between neuron and neuron.

An ANN may be defined by the following three factors: (1) a connection pattern between neurons on different layers; (2) a learning process that updates synaptic weights; and (3) an activation function generating an output value from a weighted sum of inputs received from a lower layer.

ANNs include, but are not limited to, network models such as a deep neural network (DNN), a recurrent neural network (RNN), a bidirectional recurrent deep neural network (BRDNN), a multilayer perception (MLP), and a convolutional neural network (CNN).

An ANN may be classified as a single-layer neural network or a multi-layer neural network, based on the number of layers therein.

A general Single-Layer Neural Network is composed of an input layer and an output layer.

In addition, a general Multi-Layer Neural Network is composed of an Input layer, one or more Hidden layers, and an Output layer.

The Input layer is a layer that accepts external data, the number of neurons in the Input layer is equal to the number of input variables, and the Hidden layer is disposed between the Input layer and the Output layer and receives a signal from the Input layer to extract the characteristics to transfer it to the Output layer. The Output layer receives a signal from the Hidden layer, and outputs an output value based on the received signal. The Input signal between neurons is multiplied by each connection strength (weight) and then summed, and if the sum is larger than the threshold of the neuron, the neuron is activated to output the output value obtained through the activation function.

A deep neural network with a plurality of hidden layers between the input layer and the output layer may be the most representative type of artificial neural network which enables deep learning, which is one machine learning technique.

The Artificial Neural Network can be trained by using training data. Herein, the training can mean a process of determining a parameter of the Artificial Neural Network by using training data in order to achieve the objects such as classification, regression, clustering, etc. of input data. As a representative example of the parameter of the Artificial Neural Network, there can be a weight given to a synapse or a bias applied to a neuron.

The Artificial Neural Network trained by the training data can classify or cluster the input data according to the pattern of the input data.

Meanwhile, the Artificial Neural Network trained by using the training data can be referred to as a trained model in the present specification.

Next, the learning method of the Artificial Neural Network will be described.

The learning method of the Artificial Neural Network can be largely classified into Supervised Learning, Unsupervised Learning, Semi-supervised Learning, and Reinforcement Learning.

The Supervised Learning is a method of the Machine Learning for inferring one function from the training data.

Then, among the thus inferred functions, outputting consecutive values is referred to as regression, and predicting and outputting a class of an input vector is referred to as classification.

In the Supervised Learning, the Artificial Neural Network is learned in a state where a label for the training data has been given.

Here, the label may refer to a target answer (or a result value) to be guessed by the artificial neural network when the training data is inputted to the artificial neural network.

Throughout the present specification, the target answer (or a result value) to be guessed by the artificial neural network when the training data is inputted may be referred to as a label or labeling data.

In addition, in the present specification, setting the label to the training data for training of the Artificial Neural Network is referred to as labeling the labeling data on the training data.

Training data and labels corresponding to the training data together may form a single training set, and as such, they may be inputted to an artificial neural network as a training set.

Meanwhile, the training data represents a plurality of features, and the labeling the label on the training data can mean that the feature represented by the training data is labeled. In this case, the training data can represent the feature of the input object in the form of a vector.

The Artificial Neural Network can infer a function of the relationship between the training data and the labeling data by using the training data and the labeling data. Then, the parameter of the Artificial Neural Network can be determined (optimized) by evaluating the function inferred from the Artificial Neural Network.

Unsupervised learning is a machine learning method that learns from training data that has not been given a label.

More specifically, unsupervised learning may be a training scheme that trains an artificial neural network to discover a pattern within given training data and perform classification by using the discovered pattern, rather than by using a correlation between given training data and labels corresponding to the given training data.

Examples of unsupervised learning include, but are not limited to, clustering and independent component analysis.

Examples of artificial neural networks using unsupervised learning include, but are not limited to, a generative adversarial network (GAN) and an autoencoder (AE).

GAN is a machine learning method in which two different artificial intelligences, a generator and a discriminator, improve performance through competing with each other.

The generator may be a model generating new data that generates new data based on true data.

The discriminator may be a model recognizing patterns in data that determines whether inputted data is from the true data or from the new data generated by the generator.

Furthermore, the generator may receive and learn from data that has failed to fool the discriminator, while the discriminator may receive and learn from data that has succeeded in fooling the discriminator. Accordingly, the generator may evolve so as to fool the discriminator as effectively as possible, while the discriminator evolves so as to distinguish, as effectively as possible, between the true data and the data generated by the generator.

An auto-encoder (AE) is a neural network which aims to reconstruct its input as output.

More specifically, AE may include an input layer, at least one hidden layer, and an output layer.

Since the number of nodes in the hidden layer is smaller than the number of nodes in the input layer, the dimensionality of data is reduced, thus leading to data compression or encoding.

Furthermore, the data outputted from the hidden layer may be inputted to the output layer. Given that the number of nodes in the output layer is greater than the number of nodes in the hidden layer, the dimensionality of the data increases, thus leading to data decompression or decoding.

Furthermore, in the AE, the inputted data is represented as hidden layer data as interneuron connection strengths are adjusted through training. The fact that when representing information, the hidden layer is able to reconstruct the inputted data as output by using fewer neurons than the input layer may indicate that the hidden layer has discovered a hidden pattern in the inputted data and is using the discovered hidden pattern to represent the information.

Semi-supervised learning is machine learning method that makes use of both labeled training data and unlabeled training data.

One semi-supervised learning technique involves reasoning the label of unlabeled training data, and then using this reasoned label for learning. This technique may be used advantageously when the cost associated with the labeling process is high.

Reinforcement learning may be based on a theory that given the condition under which a reinforcement learning agent can determine what action to choose at each time instance, the agent can find an optimal path to a solution solely based on experience without reference to data.

The Reinforcement Learning can be mainly performed by a Markov Decision Process (MDP).

Markov decision process consists of four stages: first, an agent is given a condition containing information required for performing a next action; second, how the agent behaves in the condition is defined; third, which actions the agent should choose to get rewards and which actions to choose to get penalties are defined; and fourth, the agent iterates until future reward is maximized, thereby deriving an optimal policy.

An artificial neural network is characterized by features of its model, the features including an activation function, a loss function or cost function, a learning algorithm, an optimization algorithm, and so forth. Also, the hyperparameters are set before learning, and model parameters can be set through learning to specify the architecture of the artificial neural network.

For instance, the structure of an artificial neural network may be determined by a number of factors, including the number of hidden layers, the number of hidden nodes included in each hidden layer, input feature vectors, target feature vectors, and so forth.

Hyperparameters may include various parameters which need to be initially set for learning, much like the initial values of model parameters. Also, the model parameters may include various parameters sought to be determined through learning.

For instance, the hyperparameters may include initial values of weights and biases between nodes, mini-batch size, iteration number, learning rate, and so forth. Furthermore, the model parameters may include a weight between nodes, a bias between nodes, and so forth.

Loss function may be used as an index (reference) in determining an optimal model parameter during the learning process of an artificial neural network. Learning in the artificial neural network involves a process of adjusting model parameters so as to reduce the loss function, and the purpose of learning may be to determine the model parameters that minimize the loss function.

Loss functions typically use means squared error (MSE) or cross entropy error (CEE), but the present disclosure is not limited thereto.

Cross-entropy error may be used when a true label is one-hot encoded. One-hot encoding may include an encoding method in which among given neurons, only those corresponding to a target answer are given 1 as a true label value, while those neurons that do not correspond to the target answer are given 0 as a true label value.

In machine learning or deep learning, learning optimization algorithms may be deployed to minimize a cost function, and examples of such learning optimization algorithms include gradient descent (GD), stochastic gradient descent (SGD), momentum, Nesterov accelerate gradient (NAG), Adagrad, AdaDelta, RMSProp, Adam, and Nadam.

GD includes a method that adjusts model parameters in a direction that decreases the output of a cost function by using a current slope of the cost function.

The direction in which the model parameters are to be adjusted may be referred to as a step direction, and a size by which the model parameters are to be adjusted may be referred to as a step size.

Here, the step size may mean a learning rate.

GD obtains a slope of the cost function through use of partial differential equations, using each of model parameters, and updates the model parameters by adjusting the model parameters by a learning rate in the direction of the slope.

SGD may include a method that separates the training dataset into mini batches, and by performing gradient descent for each of these mini batches, increases the frequency of gradient descent.

Adagrad, AdaDelta and RMSProp may include methods that increase optimization accuracy in SGD by adjusting the step size, and may also include methods that increase optimization accuracy in SGD by adjusting the momentum and step direction. Adam may include a method that combines momentum and RMSProp and increases optimization accuracy in SGD by adjusting the step size and step direction. Nadam may include a method that combines NAG and RMSProp and increases optimization accuracy by adjusting the step size and step direction.

Learning rate and accuracy of an artificial neural network rely not only on the structure and learning optimization algorithms of the artificial neural network but also on the hyperparameters thereof. Therefore, in order to obtain a good learning model, it is important to choose a proper structure and learning algorithms for the artificial neural network, but also to choose proper hyperparameters.

In general, the artificial neural network is first trained by experimentally setting hyperparameters to various values, and based on the results of training, the hyperparameters can be set to optimal values that provide a stable learning rate and accuracy.

Furthermore, the image noise processing apparatus 100 may re-train the artificial intelligence model, which is trained by the learning device 200, using personal data of a user on the basis of a transfer learning method. The image noise processing apparatus 100 may use various artificial intelligence application programs, provided by the learning device, 200 during a process of re-training or executing the artificial intelligence model.

According to an exemplary embodiment of the present disclosure, an image processing method based on a deep neural network such as deep learning may include two types of method. According to one of the methods, a deep learning model is newly trained, and according to the other method, a pre-trained deep learning model is used.

Basic training of a deep learning model, i.e., training of a deep network, requires a process of learning features and completing a model by collecting a large amount of label-designated training data sets and designing a network architecture. Although an excellent result may be obtained through the training of the deep network, this method requires a massive amount of training data sets, and makes it necessary to set a weight and layer for a used network, such as a convolutional neural network (CNN).

A plurality of deep learning application programs used in a pre-trained deep learning model may use transfer learning, which is a process including a method of minutely adjusting a pre-trained model. According to this transfer learning method, new data including a previously unknown class may be inputted to an existing deep network such as AlexNet or GoogLeNet.

By using this transfer learning method, time consumption may be reduced and a result may be quickly calculated since a model is pre-trained with big data-size image data.

The deep learning model provides high precision when extracting noise using image data, but requires a large amount of training data sets for accurate prediction.

The image noise processing apparatus 100 according to an exemplary embodiment of the present disclosure may use, as one of a deep learning model, a CNN model trained by using collected image data of the user as input data. The CNN may classify extracted features into unique categories to extract noise from an input image.

Image noise processing based on machine learning may include a process of manually extracting features and classifying the extracted features. For example, a HOG feature extraction method using a support vector machine (SVM) learning algorithm may be used in an exemplary embodiment of the present disclosure. Other feature extraction algorithms, such as Harris corner, Shi & Tomasi, SIFT-DoG, FAST, AGAST, and major invariant feature (SURF, BRIEF, ORB) methods, may be used.

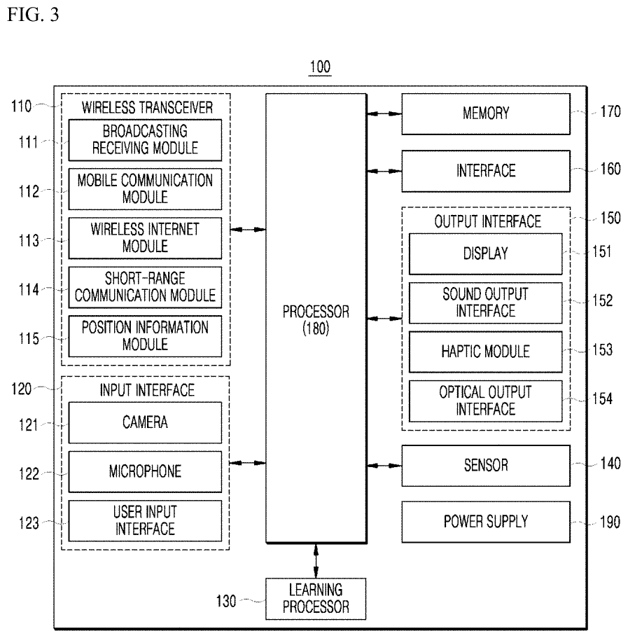

FIG. 3 is block diagram illustrating a terminal corresponding to an image noise processing apparatus according to an exemplary embodiment of the present disclosure.

The terminal 100 may be implemented as a stationary terminal and a mobile terminal, such as a mobile phone, a projector, a mobile phone, a smartphone, a laptop computer, a terminal for digital broadcast, a personal digital assistant (PDA), a portable multimedia player (PMP), a navigation system, a slate PC, a tablet PC, an ultrabook, a wearable device (for example, a smartwatch, a smart glass, and a head mounted display (HMD)), a set-top box (STB), a digital multimedia broadcast (DMB) receiver, a radio, a laundry machine, a refrigerator, a desktop computer, a digital signage.

That is, the terminal 100 may be implemented as various home appliances used at home and also applied to a fixed or mobile robot.

The terminal 100 may perform a function of a voice agent. The voice agent may be a program which recognizes a voice of the user and outputs a response appropriate for the recognized voice of the user as a voice.

Referring to FIG. 3, the terminal 100 may include a wireless transceiver 110, an input interface 120, a learning processor 130, a sensor 130, an output interface 150, an interface 160, a memory 170, a processor 180, and a power supply 190.

A trained model may be loaded in the terminal 100.

In the meantime, the learning model may be implemented by hardware, software, or a combination of hardware and software. When a part or all of the learning model is implemented by software, one or more commands which configure the learning model may be stored in the memory 170.

The wireless transceiver 110 may include at least one of a broadcasting receiving module 111, a mobile communication module 112, a wireless internet module 113, a short-range communication module 114, and a position information module 115.

The broadcasting receiving module 111 receives a broadcasting signal and/or broadcasting related information from an external broadcasting management server through a broadcasting channel.

The mobile communication module 112 may transmit/receive a wireless signal to/from at least one of a base station, an external terminal, and a server on a mobile communication network established according to the technical standards or communication methods for mobile communication (for example, Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), and Long Term Evolution-Advanced (LTE-A)).

The wireless internet module 113 refers to a module for wireless internet access and may be built in or external to the equipment 100. The wireless internet module 113 may be configured to transmit/receive a wireless signal in a communication network according to wireless internet technologies.

The wireless internet technologies may include Wireless LAN (WLAN), Wireless-Fidelity (Wi-Fi), Wi-Fi Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), and Long Term Evolution-Advanced (LTE-A).

The short-range communication module 114 may support Short-range communication by using at least one of Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies.

The location information module 115 is a module for obtaining the location (or the current location) of a mobile terminal, and its representative examples include a global positioning system (GPS) module or a Wi-Fi module. For example, the mobile terminal may obtain its position by using a signal transmitted from a GPS satellite through the GPS module.

The input interface 120 may include a camera 121 which inputs an image signal, a microphone 122 which receives an audio signal, and a user input interface 123 which receives information from the user.

Voice data or image data collected by the input interface 120 is analyzed to be processed as a control command of the user.

The input interface 120 may obtain training data for training a model and input data used to obtain an output using the trained model.

The input interface 120 may obtain input data which is not processed, and, in this case, the processor 180 or the learning processor 130 pre-processes the obtained data to generate training data to be input to the model learning or pre-processed input data.

Here, the preprocessing of input data may refer to extracting an input feature from the input data.

The input interface 120 is provided to input image information (or signal), audio information (or signal), data, or information input from the user and in order to input the image information, the terminal 100 may include one or a plurality of cameras 121.

The camera 121 processes an image frame such as a still image or a moving image obtained by an image sensor in a video call mode or a photographing mode. The processed image frame may be displayed on the display 151 or stored in the memory 170.

The microphone 122 processes an external sound signal as electrical voice data. The processed voice data may be utilized in various forms in accordance with a function which is being performed by the terminal 100 (or an application program which is being executed). In the meantime, in the microphone 122, various noise removal algorithms which remove noise generated during the process of receiving the external sound signal may be implemented.

The user input interface 123 receives information from the user and when the information is input through the user input interface 123, the processor 180 may control the operation of the terminal 100 so as to correspond to the input information.

The user input interface 123 may include a mechanical input interface (or a mechanical key, for example, a button located on a front, rear, or side surface of the terminal 100, a dome switch, a jog wheel, or a jog switch) and a touch type input interface. For example, the touch type input interface may be formed by a virtual key, a soft key, or a visual key which is disposed on the touch screen through a software process or a touch key which is disposed on a portion other than the touch screen.

The learning processor 130 learns the model configured by an artificial neural network using the training data.

Specifically, the learning processor 130 repeatedly trains the artificial neural network using the aforementioned various learning techniques to determine optimized model parameters of the artificial neural network.

In this specification, the artificial neural network which is trained using training data to determine parameters may be referred to as a learning model or a trained model.

In this case, the learning model may be used to deduce a result for the new input data, rather than the training data.

The learning processor 130 may be configured to receive, classify, store, and output information to be used for data mining, data analysis, intelligent decision making, and machine learning algorithm and techniques.

The learning processor 130 may include one or more memory units configured to store data which is received, detected, sensed, generated, previously defined, or output by another component, device, the terminal, or a device which communicates with the terminal.

The learning processor 130 may include a memory which is combined with or implemented in the terminal. In some exemplary embodiments, the learning processor 130 may be implemented using the memory 170.

Selectively or additionally, the learning processor 130 may be implemented using a memory related to the terminal, such as an external memory which is directly coupled to the terminal or a memory maintained in the server which communicates with the terminal.

According to another exemplary embodiment, the learning processor 130 may be implemented using a memory maintained in a cloud computing environment or other remote memory locations accessible by the terminal via a communication method such as a network.

The learning processor 130 may be configured to store data in one or more databases to identify, index, categorize, manipulate, store, search, and output data in order to be used for supervised or non-supervised learning, data mining, predictive analysis, or used in the other machine. Here, the database may be implemented using the memory 170, a memory 230 of the learning device 200, a memory maintained in a cloud computing environment or other remote memory locations accessible by the terminal via a communication method such as a network.

Information stored in the learning processor 130 may be used by the processor 180 or one or more controllers of the terminal using an arbitrary one of different types of data analysis algorithms and machine learning algorithms.

As an example of such an algorithm, a k-nearest neighbor system, fuzzy logic (for example, possibility theory), a neural network, a Boltzmann machine, vector quantization, a pulse neural network, a support vector machine, a maximum margin classifier, hill climbing, an inductive logic system, a Bayesian network, (for example, a finite state machine, a Mealy machine, a Moore finite state machine), a classifier tree (for example, a perceptron tree, a support vector tree, a Markov Tree, a decision tree forest, an arbitrary forest), a reading model and system, artificial fusion, sensor fusion, image fusion, reinforcement learning, augmented reality, pattern recognition, automated planning, and the like, may be provided.

The processor 180 may determine or predict at least one executable operation of the terminal based on information which is determined or generated using the data analysis and the machine learning algorithm. To this end, the processor 180 may request, search, receive, or utilize the data of the learning processor 130 and control the terminal to execute a predicted operation or a desired operation among the at least one executable operation.

The processor 180 may perform various functions which implement intelligent emulation (that is, a knowledge based system, an inference system, and a knowledge acquisition system). This may be applied to various types of systems (for example, a fuzzy logic system) including an adaptive system, a machine learning system, and an artificial neural network.

The processor 180 may include sub modules which enable operations involving voice and natural language voice processing, such as an I/O processing module, an environmental condition module, a speech to text (STT) processing module, a natural language processing module, a workflow processing module, and a service processing module.

The sub modules may have an access to one or more systems or data and a model, or a subset or a super set thoseof in the terminal. Further, each of the sub modules may provide various functions including a glossarial index, user data, a workflow model, a service model, and an automatic speech recognition (ASR) system.

According to another exemplary embodiment, another aspect of the processor 180 or the terminal may be implemented by the above-described sub module, a system, data, and a model.

In some exemplary embodiments, based on the data of the learning processor 130, the processor 180 may be configured to detect and sense requirements based on contextual conditions expressed by user input or natural language input or user's intention.

The processor 180 may actively derive and obtain information required to completely determine the requirement based on the contextual conditions or the user's intention. For example, the processor 180 may actively derive information required to determine the requirements, by analyzing past data including historical input and output, pattern matching, unambiguous words, and input intention.

The processor 180 may determine a task flow to execute a function responsive to the requirements based on the contextual condition or the user's intention.

The processor 180 may be configured to collect, sense, extract, detect and/or receive a signal or data which is used for data analysis and a machine learning task through one or more sensing components in the terminal, to collect information for processing and storing in the learning processor 130.

The information collection may include sensing information by a sensor, extracting of information stored in the memory 170, or receiving information from other equipment, an entity, or an external storage device through a transceiver.

The processor 180 collects usage history information from the terminal and stores the information in the memory 170.

The processor 180 may determine best matching to execute a specific function using stored usage history information and predictive modeling.

The processor 180 may receive or sense surrounding environment information or other information through the sensor 140.

The processor 180 may receive a broadcasting signal and/or broadcasting related information, a wireless signal, or wireless data through the wireless transceiver 110.

The processor 180 may receive image information (or a corresponding signal), audio information (or a corresponding signal), data, or user input information from the input interface 120.

The processor 180 may collect the information in real time, process or classify the information (for example, a knowledge graph, a command policy, a personalized database, or a conversation engine) and store the processed information in the memory 170 or the learning processor 130.

When the operation of the terminal is determined based on data analysis and a machine learning algorithm and technology, the processor 180 may control the components of the terminal to execute the determined operation. Further, the processor 180 may control the equipment in accordance with the control command to perform the determined operation.

When a specific operation is performed, the processor 180 analyzes history information indicating execution of the specific operation through the data analysis and the machine learning algorithm and technology and updates the information which is previously learned based on the analyzed information.

Therefore, the processor 180 may improve precision of a future performance of the data analysis and the machine learning algorithm and technology based on the updated information, together with the learning processor 130.

The sensing unit 140 may include one or more sensors which sense at least one of information in the mobile terminal, surrounding environment information around the mobile terminal, and user information.

For example, the sensor 140 may include at least one of a proximity sensor, an illumination sensor, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor (for example, a camera 121), a microphone 122, a battery gauge, an environment sensor (for example, a barometer, a hygrometer, a thermometer, a radiation sensor, a thermal sensor, or a gas sensor), and a chemical sensor (for example, an electronic nose, a healthcare sensor, or a biometric sensor). On the other hand, the terminal 100 disclosed in the present disclosure may combine various kinds of information sensed by at least two of the above-mentioned sensors and may use the combined information.

The output interface 150 is intended to generate an output related to a visual, aural, or tactile stimulus and may include at least one of a display 151, sound output interface 152, haptic module 153, and optical output interface 154.

The display 151 displays (outputs) information processed in the equipment 100. For example, the display 151 may display execution screen information of an application program driven in the terminal 100 and user interface (UI) and graphic user interface (GUI) information in accordance with the execution screen information.

The display 151 forms a mutual layered structure with a touch sensor or is formed integrally to be implemented as a touch screen. The touch screen may simultaneously serve as a user input interface 123 which provides an input interface between the terminal 100 and the user and provide an output interface between the terminal 100 and the user.

The sound output interface 152 may output audio data received from the wireless transceiver 110 or stored in the memory 170 in a call signal reception mode, a phone-call mode, a recording mode, a voice recognition mode, or a broadcasting reception mode.

The sound output interface 152 may include at least one of a receiver, a speaker, and a buzzer.

The haptic module 153 may generate various tactile effects that the user may feel. A representative example of the tactile effect generated by the haptic module 153 may be vibration.

The optical output interface 154 outputs a signal for notifying occurrence of an event using light of a light source of the terminal 100. Examples of the event generated in the terminal 100 may be message reception, call signal reception, missed call, alarm, schedule notification, email reception, and information reception through an application.

The interface 160 serves as a passage with various types of external devices which are connected to the terminal 100. The interface 160 may include at least one of a wired/wireless headset port, an external charger port, a wired/wireless data port, a memory card port, a port which connects a device equipped with an identification module, an audio input/output (I/O) port, a video input/output (I/O) port, and an earphone port. The terminal 100 may perform appropriate control related to the connected external device in accordance with the connection of the external device to the interface 160.

In the meantime, the identification module is a chip in which various information for authenticating a usage right of the terminal 100 is stored and includes a user identification module (UIM), a subscriber identify module (SIM), and a universal subscriber identity module (USIM). The device with an identification module (hereinafter, “identification device”) may be manufactured as a smart card. Therefore, the identification device may be connected to the terminal 100 through the interface 160.

The memory 170 stores data which supports various functions of the terminal 100.

The memory 170 may store various application programs (or applications) driven in the terminal 100, data for the operation of the terminal 100, commands, and data (for example, at least one algorithm information for machine learning) for the operation of the learning processor 130.

The memory 170 may store the model which is learned in the learning processor 130 or the learning device 200.

If necessary, the memory 170 may store the trained model by dividing the model into a plurality of versions depending on a training timing or a training progress.

In this case, the memory 170 may store input data obtained from the input interface 120, learning data (or training data) used for model learning, a learning history of the model, and so forth.

In this case, the input data stored in the memory 170 may be not only data which is processed to be suitable for the model learning but also input data itself which is not processed.

In addition to the operation related to the application program, the processor 180 may generally control an overall operation of the terminal 100. The processor 180 may process a signal, data, or information which is input or output through the above-described components or drives the application programs stored in the memory 170 to provide or process appropriate information or functions to the user.

Further, in order to drive the application program stored in the memory 170, the processor 180 may control at least some of components described with reference to FIG. 3. Moreover, the processor 180 may combine and operate at least two of components included in the terminal 100 to drive the application program.

In the meantime, as described above, the processor 180 may control an operation related to the application program and an overall operation of the terminal 100. For example, when the state of the terminal satisfies a predetermined condition, the processor 180 may execute or release a locking state which restricts an input of a control command of a user for the applications.

The power supply 190 is applied with external power or internal power to supply the power to the components included in the terminal 100 under the control of the processor 180. The power supply 190 includes a battery and the battery may be an embedded battery or a replaceable battery.

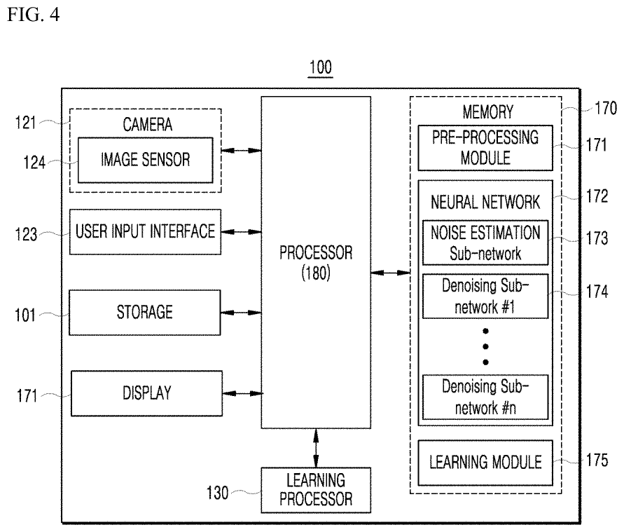

FIG. 4 is a block diagram illustrating the memory of FIG. 3.

FIG. 4 schematically illustrates components of the memory 170 included in the terminal 100 as the image noise processing apparatus 100. Various computer program modules may be loaded on the memory 170. Computer programs which may be loaded on the memory 170 include application programs such as a pre-processing module 171, a noise estimation sub-network 173, a denoising sub-network 174, and a learning module 175 in addition to system programs for managing hardware and an operating system.

Functions of the pre-processing module 171 related to pre-processing of an input image, for example, adjustment of a size, brightness, white balance, and gamma value of the image, may be executed through various calculation functions of the processor 180.

An input image noise level estimation function related to the noise estimation sub-network 173 configured within a neural network 172 may be executed through various calculation functions of the processor 180.

A function, which is related to the denoising sub-network 174, of selecting a denoising sub-network corresponding to an estimated noise level and processing noise of an input image using the selected denoising sub-network may be executed through various calculation functions of the processor 180.

A function, which is related to the learning module 175, of re-training a pre-trained artificial intelligence model, for example, a deep neural network, using personal data of the user may be executed through various calculation functions of the processor 180 or the learning processor 130.

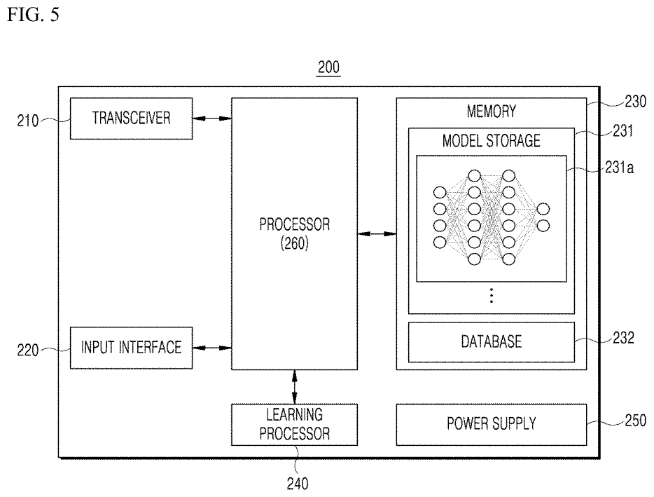

FIG. 5 is a block diagram illustrating a learning device according to an exemplary embodiment of the present disclosure.

The learning device 200 is a device or a server which is separately configured at the outside of the terminal 100 and may perform the same function as the learning processor 130 of the terminal 100.

That is, the learning device 200 may be configured to receive, classify, store, and output information to be used for data mining, data analysis, intelligent decision making, and machine learning algorithms. Here, the machine learning algorithm may include a deep learning algorithm.

The learning device 200 may communicate with at least one terminal 100 and derive a result by analyzing or learning the data on behalf of the terminal 100. Here, the meaning of “on behalf of the other device” may be distribution of a computing power by means of distributed processing.

The learning device 200 of the artificial neural network is various devices for learning an artificial neural network and normally, refers to a server, and also referred to as a learning device or a learning server.

Specifically, the learning device 200 may be implemented not only by a single server, but also by a plurality of server sets, a cloud server, or a combination thereof.

That is, the learning device 200 is configured as a plurality of learning devices to configure a learning device set (or a cloud server) and at least one learning device 200 included in the learning device set may derive a result by analyzing or learning the data through the distributed processing.

The learning device 200 may transmit a model trained by the machine learning or the deep learning to the terminal 100 periodically or upon the request.

Referring to FIG. 5, the learning device 200 may include a transceiver 210, an input interface 220, a memory 230, a learning processor 240, a power supply 250, a processor 260, and so forth.

The transceiver 210 may correspond to a configuration including the wireless transceiver 110 and the interface 160 of FIG. 3. That is, the transceiver may transmit and receive data with the other device through wired/wireless communication or an interface.

The input interface 220 is a configuration corresponding to the input interface 120 of FIG. 3 and may receive the data through the transceiver 210 to obtain data.

The input interface 220 may obtain input data for acquiring an output using training data for model learning and a trained model.

The input interface 220 may obtain input data which is not processed, and, in this case, the processor 260 may pre-process the obtained data to generate training data to be input to the model learning or pre-processed input data.

In this case, the pre-processing on the input data performed by the input interface 220 may refer to extracting of an input feature from the input data.

The memory 230 is a configuration corresponding to the memory 170 of FIG. 3.

The memory 230 may include a model storage 231, a database 232, and so forth.

The model storage 231 stores a model (or an artificial neural network 231a) which is learning or trained through the learning processor 240 and when the model is updated through the learning, stores the updated model.

If necessary, the model storage 231 stores the trained model by dividing the model into a plurality of versions depending on a training timing or a training progress.

The artificial neural network 231a illustrated in FIG. 5 is one example of artificial neural networks including a plurality of hidden layers but the artificial neural network of the present disclosure is not limited thereto.

The artificial neural network 231a may be implemented by hardware, software, or a combination of hardware and software. When a part or all of the artificial neural network 231a is implemented by the software, one or more commands which configure the artificial neural network 231a may be stored in the memory 230.

The database 232 stores input data obtained from the input interface 220, learning data (or training data) used to learn a model, a learning history of the model, and so forth.

The input data stored in the database 232 may be not only data which is processed to be suitable for the model learning but also input data itself which is not processed.

The learning processor 240 is a configuration corresponding to the learning processor 130 of FIG. 3.

The learning processor 240 may train (or learn) the artificial neural network 231a using training data or a training set.

The learning processor 240 may immediately obtain data which is obtained by pre-processing input data obtained by the processor 260 through the input interface 220 to learn the artificial neural network 231a or obtain the pre-processed input data stored in the database 232 to learn the artificial neural network 231a.

Specifically, the learning processor 240 repeatedly may train the artificial neural network 231a using various learning techniques described above to determine optimized model parameters of the artificial neural network 231a.

In this specification, the artificial neural network which is trained using training data to determine parameters may be referred to as a learning model or a trained model.

Here, the trained model may infer result values even while being installed in a learning device 200 of an artificial neural net and may be transferred to and installed in another device such as a terminal 100 by a transceiver 210.

Further, when the learning model is updated, the updated learning model may be transmitted to the other device such as the terminal 100 via the transceiver 210 to be loaded.

The power supply 250 corresponds to the power supply 190 of FIG. 3.

A redundant description for corresponding configurations will be omitted.

Referring back to FIG. 2, the image noise processing apparatus 100, according to an exemplary embodiment of the present disclosure, may be implemented in the form of the terminal 100. FIG. 4 illustrates that the memory 170 of the terminal 100 includes the pre-processing module 171, the neural network 172, and the learning module 175. At least one of the pre-processing module 171, the neural network 172, or the learning module 175 may be loaded on the memory 170 after being downloaded from the learning device 200. The neural network 172 may include a plurality of sub-networks, and the sub-networks may include the noise estimation sub-network 173 and the plurality of denoising sub-networks 174 according to a noise level.

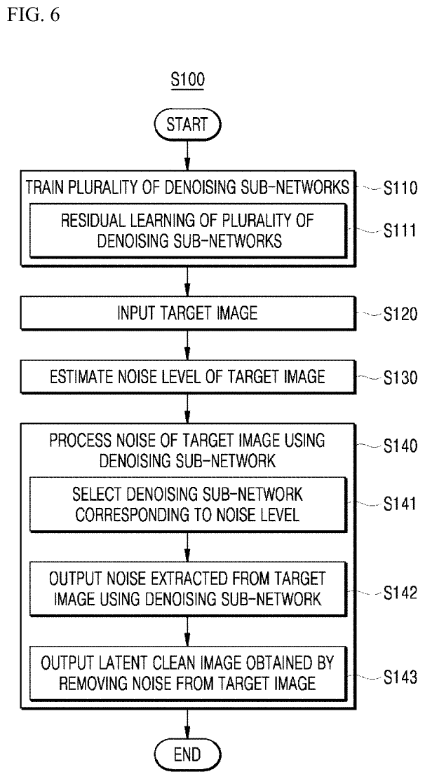

FIG. 6 is a flowchart illustrating an image noise processing method according to an exemplary embodiment of the present disclosure.

Referring to FIG. 6, prior to noise processing of a target image, the plurality of denoising sub-networks 174 may be trained to process noise of an input image on the basis of deep learning (S110).

In detail, the noise processing training (S110) may include inputting a pair of input images, including noise, analyzing the noise using the difference between the input images, and outputting a residual image by separating a latent clean image from one input image of the pair of input images on the basis of a noise difference. Here, the residual image corresponds to the noise of the input images.

The pair of input images corresponds to images having the same object as a subject and captured using the same focal distance and the same composition. Furthermore, the noise of the pair of input images includes noise which naturally occurs since the images are captured in a low light environment.

As a result, by using the pair of input images as input data of a training data set, it is possible to perform noise analysis by using the difference between noises without using a ground truth image corresponding to a latent clean image. Furthermore, it is also possible to perform noise analysis by using a pair of input images, including different noises, without artificially adding noise to the ground truth image.

Noise included in an input image for a training operation and noise included in a target image for an inference operation according to an exemplary embodiment of the present disclosure may include at least one of addictive white Gaussian noise, non-Gaussian white noise, or photon shot noise.

Furthermore, noise included in an image used in an exemplary embodiment of the present disclosure may follow at least one of a Gaussian distribution, a Poisson distribution, or a Bernoulli distribution.

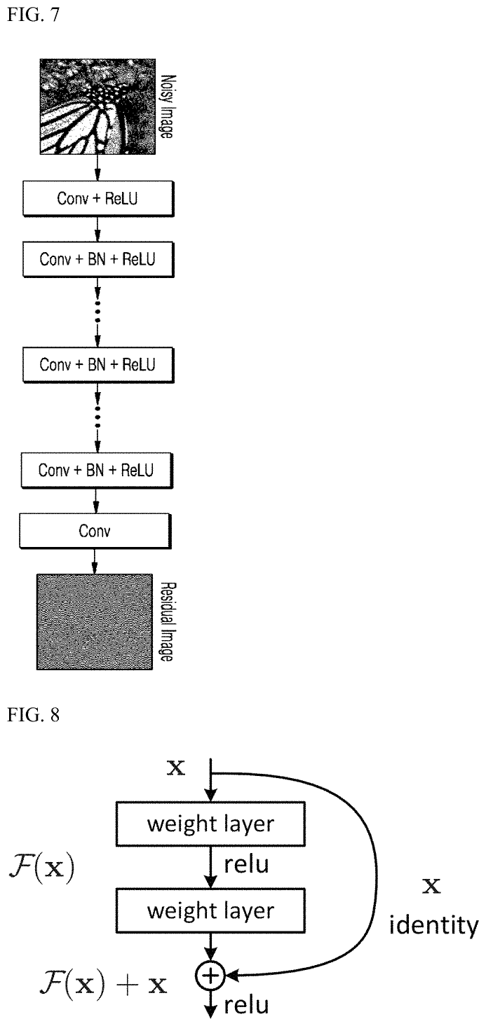

FIG. 7 is an exemplary diagram illustrating a denoising sub-network according to an exemplary embodiment of the present disclosure.

FIG. 7 illustrates a denoising sub-network according to an exemplary embodiment of the present disclosure. An input image including noise is inputted as input data. Furthermore, noise which is a residual image obtained by removing a latent clean image from a target image is outputted as output data.

The denoising sub-network 174 may include 17 to 20 layers so as to have a layer depth D. Here, three types of layers may be used. A first type is a Conv+ReLU layer which is a first layer. Furthermore, filters, as many as the number of feature maps to be created, may be used. Rectified linear units may be used with regard to non-linearity. An activation function corresponding to ReLU is a function including an input image, a weight, and a bias. Here, the weight corresponds to a filter having a certain size. The number of filters indicates the number of feature maps for extracting a feature.

A second type is a Conv+BN+ReLU layer which is applied to second to D-lth layers. Here, BN represents batch normalization. In this layer, a plurality of filters and the batch normalization may be used. The batch normalization is inserted between Cony and ReLU layers.

ReLU and BN may be used to resolve a problem of vanishing/exploding gradient.

FIG. 8 is an exemplary diagram illustrating residual learning according to an exemplary embodiment of the present disclosure.

The plurality of denoising sub-networks may be trained to process noise of an input image on the basis of residual learning (S111).

Referring to FIG. 8, the residual learning represents adding a specified skip connection to an existing network. FIG. 8 illustrates that an input is directly added to an output that has undergone two weight layers, and this configuration is referred to as a residual learning block.

In Equation 4, H(x) denotes a target to be finally learned, F(x) denotes an output of a stacked layer, and x denotes an input.

H(x)=F(x)+x [Equation 4]

The block may be generated in the form expressed by Equation 4. With regard to Equation 5, F(x) is required to learn only a difference of inputs in comparison with a case in which a skip connection is not present, and thus this learning is referred to as residual learning.

F(x)=H(x)−x [Equation 5]

The deep learning-based denoising sub-network 174 according to an exemplary embodiment of the present disclosure may include ResNet capable of performing the residual learning. The denoising sub-network 174 may learn, through the residual learning, a difference between noises corresponding to a difference between a first image and a second image of an input image pair which include a common latent clean image. This indicates that noise learning is possible even when the latent clean image is not inputted as input data of a network. In addition, the denoising sub-network may output a learned noise, and the latent clean image, generated by removing noise from the input image on the basis of the output noise, may be obtained.

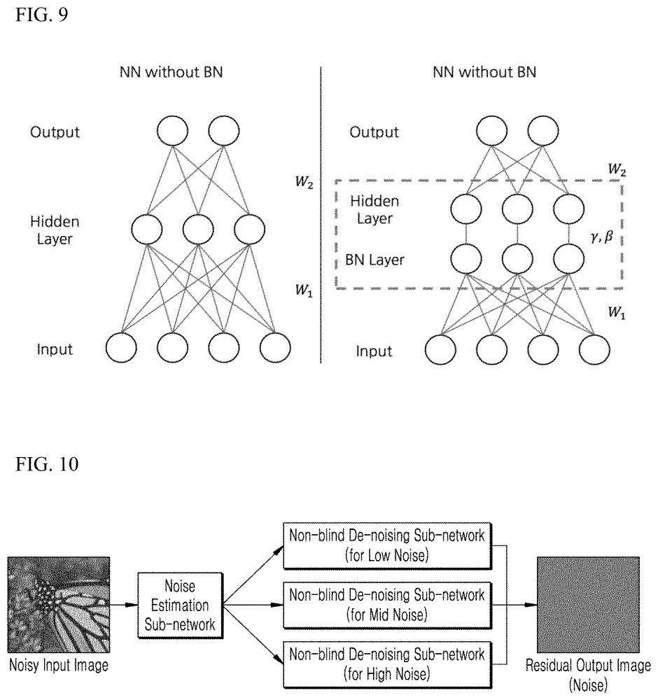

FIG. 9 is an exemplary diagram illustrating batch normalization according to an exemplary embodiment of the present disclosure.

Referring to FIG. 9, the denoising sub-network 174 according to an exemplary embodiment of the present disclosure may include batch normalization.

The batch normalization represents an operation of normalizing an activation value or output value of an activation function. That is, the batch normalization is an operation of normalizing a distribution of data in each layer of a neural network. An input distribution becomes regular by performing normalization on each hidden layer, and accordingly, it is possible to set a higher learning rate. As a result, a learning speed becomes faster.

A third type is a Cony layer corresponding to a last layer. This layer is used when reconstructing an output.

After the plurality of denoising sub-networks are completed by training, a target image including noise, such as noise caused by an image captured in a low light environment, may be inputted to a neural network as a test image (S120).

A noise processing method using an artificial intelligence model includes blind denoising, that does not include estimation of a noise level, and non-blind denoising that includes estimation of a noise level. The blind denoising has an advantage of low computational complexity, but has a low noise removal performance. On the contrary, the non-blind denoising has a disadvantage of high computational complexity, but has a high noise removal performance.

The terminal 100 corresponding to the image noise processing apparatus according to an exemplary embodiment of the present disclosure may include the non-blind denoising sub-network 174 for improving the noise removal performance, and may also include the noise estimation sub-network 173, independent of the denoising sub-network 174, in order to reduce the computational complexity.

The processor 180 may estimate a noise level of the target image using the noise estimation sub-network 173 (S130). The processor 180 may use block based approaches or filter based approaches in order to estimate a noise level.

In general, noise level information is provided by noise standard deviation. During a noise level estimation process, a large number of filters may be used to adaptively change smoothing effects.

In an exemplary embodiment of the present disclosure, various types of noise level estimation methods based on the block based approaches or filter based approaches may be used.

In detail, according to the block based approaches, an image is divided into a sequence of blocks, and 6 is estimated by appropriately calculating a weighted noise level obtained by finding an average of noise levels of most homogenous blocks.

On the contrary, according to the filter based approaches, a pre-filtering operation is performed on a region in which a noise image is displayed in a blurred state in order to expose an image structure. An image difference is calculated by subtracting an image filtered from a target image. Therefore, a noise level is estimated on the basis of the image difference considered to include a pure noise signal.

The processor 180 may process noise of the target image using the denoising sub-network according to the noise level (S140). Operation S140 may include selecting a denoising sub-network (S141), outputting noise using the denoising sub-network (S142), and outputting a latent clean image (S143).

The processor 180 may select the denoising sub-network 174 corresponding to the noise level by using a result of the noise level estimation S130 (S141).

Here, the processor 180 may select the denoising sub-network 174 corresponding to the noise level according to at least one of the number of layers of a neural network, the amount of training data sets, and a number of times the training data sets have been used for learning. That is, the processor 180 may select the denoising sub-network which exhibits performance in proportion to the degree of noise.

The image noise processing method S100 according to an exemplary embodiment of the present disclosure may use a method of analyzing noise, extracting the noise according to a noise analysis result, and removing the extracted noise from a target image.

The processor 180 may extract noise from the target image using the selected denoising sub-network, and may output this noise (S142).

FIG. 10 is an exemplary diagram illustrating a neural network according to an exemplary embodiment of the present disclosure.

FIG. 10 illustrates the denoising sub-network 174 according to an exemplary embodiment of the present disclosure, which receives an image including noise, i.e., a target image, and processes this image in order to output a residual image.

The processor 180 may estimate a noise level using the noise estimation sub-network 173, may select a denoising sub-network that performs in correspondence with an estimated noise level for the purpose of performing a noise analysis using the selected denoising sub-network, and may control the denoising sub-network in order to output a residual image including noise.

FIG. 10 illustrates three denoising sub-networks corresponding to a low noise level, an intermediate noise level, and a high noise level. However, the number of denoising sub-networks that may be selected in an embodiment of the present disclosure is not limited to the number of the denoising sub-networks of FIG. 10, and n (natural number) number of denoising sub-networks may be provided according to a noise level.

The processor 180 may finally output a latent clean image obtained by removing noise from the target image (S143). The processor 180 may output the latent clean image, obtained by removing noise from the target image, using the noise analyzed by the denoising sub-network 174 trained through operation S110.

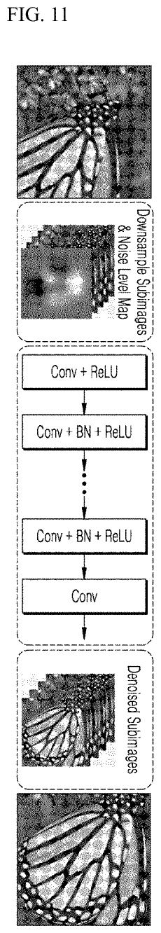

FIG. 11 is an exemplary diagram illustrating a denoising sub-network according to an exemplary embodiment of the present disclosure.

Referring to FIG. 11, when estimating a noise level of a target image, the processor 180 may divide the target image into a plurality of sub-images according to an estimated noise level. Furthermore, the processor 180 may generate a noise map indicating a noise distribution for the sub-image. Furthermore, when processing the target image, the processor 180 may process the target image using a denoising sub-network corresponding to the noise level of the sub-image on the basis of the noise map.

The processor 180 is capable of processing noise included in the target image with a small number of layers and low computational complexity by dividing the target image according to a noise level and selectively using denoising sub-networks having different performances according to divided target images.

As described above, according to an exemplary embodiment of the present disclosure, a low light level noise may be selectively processed by a denoising sub-network having an appropriate performance according to a result of noise level estimation.

Furthermore, noise of a low light level image may be efficiently removed through residual learning using subtraction between noises.

Furthermore, a low light level noise may be removed through learning for which an image, including an actual noise rather than a virtual noise, is used as training data.

Embodiments according to the present disclosure described above may be implemented in the form of computer programs that may be executed through various components on a computer, and such computer programs may be recorded in a computer-readable medium. Examples of the computer-readable media include, but are not limited to: magnetic media such as hard disks, floppy disks, and magnetic tape; optical media such as CD-ROM disks and DVD-ROM disks; magneto-optical media such as floptical disks; and hardware devices that are specially configured to store and execute program codes, such as ROM, RAM, and flash memory devices.

Meanwhile, the computer programs may be those specially designed and constructed for the purposes of the present disclosure or they may be of the kind well known and available to those skilled in the computer software arts. Examples of program code include both machine codes, such as produced by a compiler, and higher level code that may be executed by the computer using an interpreter.

As used in the present disclosure (especially in the appended claims), the singular forms “a,” “an,” and “the” include both singular and plural references, unless the context clearly states otherwise. Also, it should be understood that any numerical range recited herein is intended to include all sub-ranges subsumed therein (unless expressly indicated otherwise) and accordingly, the disclosed numeral ranges include every individual value between the minimum and maximum values of the numeral ranges.

Operations constituting the method of the present disclosure may be performed in appropriate order unless explicitly described in terms of order or described to the contrary. The present disclosure is not necessarily limited to the order of operations given in the description. All examples described herein or the terms indicative thereof (“for example,” etc.) used herein are merely to describe the present disclosure in greater detail. Therefore, it should be understood that the scope of the present disclosure is not limited to the exemplary embodiments described above or by the use of such terms unless limited by the appended claims. Also, it should be apparent to those skilled in the art that various modifications, combinations, and alternations can be made depending on design conditions and factors within the scope of the appended claims or equivalents thereof.

Therefore, technical ideas of the present disclosure are not limited to the above-mentioned embodiments, and it is intended that not only the appended claims, but also all changes equivalent to claims, should be considered to fall within the scope of the present disclosure.

What is claimed is:

1. An image noise processing method performed by an image noise processing apparatus, the image noise processing method comprising:
receiving a target image through a neural network comprising a plurality of sub-networks;
estimating a noise level of the target image using a noise estimation sub-network from among the plurality of sub-networks; and
processing the target image using a denoising sub-network corresponding to the noise level among the plurality of sub-networks.

2. The image noise processing method of claim 1, wherein the noise comprises at least one of an addictive white Gaussian noise, a non-Gaussian white noise, or a photon shot noise.

3. The image noise processing method of claim 1, wherein the noise follows at least one of a Gaussian distribution, a Poisson distribution, or a Bernoulli distribution.

4. The image noise processing method of claim 1, wherein the estimating of the noise level of the target image comprises a block based approach or a filter based approach.

5. The image noise processing method of claim 1,
wherein the estimating of the noise level of the target image comprises:
dividing the target image into a plurality of sub-images according to the estimated noise level; and
generating a noise map indicating a noise distribution for the sub-image,
wherein the processing of the target image comprises:
processing the target image using the denoising sub-network corresponding to the noise level of the sub-image on the basis of the noise map.

6. The image noise processing method of claim 1, wherein the processing of the target image comprises selecting the denoising sub-network corresponding to the noise level according to at least one of a number of layers constituting the neural network, an amount of training data sets, and a number of times the training data sets have been used for learning.

7. The image noise processing method of claim 1, further comprising training the denoising sub-network using residual learning based on learning of a noise difference due to a difference in a pair of input images.

8. The image noise processing method of claim 1, wherein the training of the denoising sub-network comprises:
receiving a pair of input images including noise;
analyzing a noise difference using a difference between the input images; and
separating a latent clean image from one input image of the pair of input images, on the basis of the noise difference, in order to output a residual image.

9. The image noise processing method of claim 8, wherein the pair of input images corresponds to images having the same object as a subject and having been captured using the same focal distance and the same composition.

10. The image noise processing method of claim 8, wherein the noise of the pair of input images comprises noise which naturally occurs due to an image having been captured in a low light environment.

11. The image noise processing method of claim 1, wherein the processing of the target image comprises:
outputting noise extracted from the target image according to a training result of residual learning of the denoising sub-network; and
outputting a latent clean image obtained by removing noise from the target image on the basis of the extracted noise.

12. An image noise processing apparatus comprising:
a neural network comprising a plurality of sub-networks; and
a processor configured to control the neural network to process noise of an inputted target image,
wherein the neural network comprises:
a noise estimation sub-network configured to estimate a grade of a noise level of the target image; and
a plurality of deep learning-based denoising sub-networks configured to process the noise of the target image using a denoising sub-network corresponding to the noise level.

13. The image noise processing apparatus of claim 12, wherein the noise estimation sub-network estimates the noise level of the target image using a block based approach or a filter based approach.

14. The image noise processing apparatus of claim 12, wherein the processor:
divides the target image into a plurality of sub-images according to the estimated noise level;
controls the noise estimation sub-network to generate a noise map indicating a noise distribution for the sub-image; and
processes the target image using the denoising sub-network corresponding to the noise level of the sub-image on the basis of the noise map.

15. The image noise processing apparatus of claim 12, wherein the processor selects the denoising sub-network corresponding to the noise level according to at least one of a number of layers constituting the neural network, an amount of training data sets, and a number of times the training data sets have been used for learning.

16. The image noise processing apparatus of claim 12, wherein the denoising sub-network performs training for outputting a residual image, which only includes noise with respect to input data of a pair of input images, by using residual learning based on learning of a noise difference due to a difference in the pair of input images.

17. The image noise processing apparatus of claim 12, wherein the denoising sub-network is trained to analyze, with respect to a pair of input images, a noise difference using a difference between the input images, and separate a latent clean image from one input image of the pair of input images on the basis of the noise difference in order to output a residual image.

18. The image noise processing apparatus of claim 16, wherein the pair of input images corresponds to images having the same object as a subject and having been captured using the same focal distance and the same composition.

19. The image noise processing apparatus of claim 16, wherein the noise of the pair of input images comprises noise which naturally occurs due to an image having been captured in a low light environment.

20. The image noise processing apparatus of claim 12, wherein the processor:
controls the denoising sub-network to output noise extracted from the target image according to a training result of residual learning of the denoising sub-network; and
outputs a latent clean image obtained by removing noise from the target image on the basis of the extracted noise.
